(19) United States
(12) Patent Application Publication
(10) Pub. No.: US 2015/0264358 A1
(43) Pub. Date: Sep. 17, 2015

(54) VIDEO TRANSMITTER, VIDEO TRANSCEIVER SYSTEM AND VIDEO TRANSMISSION METHOD

(71) Applicant: KABUSHIKI KAISHA TOSHIBA, Tokyo (JP)

(72) Inventor: Akira Moriya, Kawasaki-Shi (JP)

(21) Appl. No.: 14/334,153

(22) Filed: Jul. 17, 2014

Related U.S. Application Data
(60) Provisional application No. 61/951,090, filed on Mar. 11, 2014.

(51) Int. Cl. H04N 19/146; H04N 19/164

(52) U.S. Cl. CPC H04N 19/146; H04N 19/164

(57) ABSTRACT

According to an embodiment, a video transmitter includes an encoding unit and a communication unit. The encoding unit is configured to encode each frame per one or more lines to generate a code, each frame making up a video signal. The communication unit is configured to transmit the code to a video receiver and configured to receive an acknowledgment from the video receiver, the acknowledgment indicating whether or not the video receiver has been able to receive the code. The encoding unit encodes a following line in consideration of the acknowledgment.

### CROSS REFERENCE TO RELATED APPLICATIONS

This application is based upon and claims the benefit of priority from the prior U.S. Provisional Patent Application No. 61/951,090, filed on Mar. 11, 2014, the entire contents of which are incorporated herein by reference.

### FIELD

Embodiments described herein relate generally to a video transmitter, a video transceiver system and a video transmission method.

### BACKGROUND

When a video signal is transmitted, it is possible to reduce the band for the transmission path by encoding and compressing the video signal. When carrying out encoding, it is possible to further increase the compression ratio by carrying out inter-frame prediction in which the correlation between frames is used.

However, due to the loss or delay of packets in the transmission path, there are cases where a video receiver is not able to receive an encoded video signal correctly. In such cases, display images may be distorted as a result of the video receiver not being able to correctly decode frames that have been encoded by means of inter-frame prediction.

If the video receiver is not able to receive a video signal correctly, it is possible to limit the distortion of display images by resending the video signal. However, a transmission delay may occur because the resending makes a lot of traffic on the path.

### BRIEF DESCRIPTION OF THE DRAWINGS

FIG. 1 is a block diagram of a video transceiver system 100 according to a first embodiment.

FIG. 2 is a drawing depicting an example of a structure of a transmission history buffer 25.

FIG. 3 is a sequence diagram depicting an example of processing performed by the video transceiver system 100.

FIG. 4 is a drawing schematically illustrating the processing performed by the video transceiver system 100.

FIG. 5 is a drawing schematically illustrating the processing performed by the video transceiver system 100.

FIG. 6 is a drawing schematically illustrating the processing performed by the video transceiver system 100.

FIG. 7 is a block diagram of a video transceiver system 100a according to a second embodiment.

FIG. 8 is a drawing depicting an example of a structure of a decoding history buffer 36.

FIG. 9 is a drawing depicting an example of a structure of a transmission history buffer 25a.

FIG. 10 is a sequence diagram depicting an example of processing performed by the video transceiver system 100a.

FIG. 11 is a drawing schematically illustrating the processing performed by the video transceiver system 100a.

FIG. 12 is a block diagram of a video transceiver system 100b according to a third embodiment.

FIG. 13 is a drawing depicting another example of a structure of a transmission history buffer 25a.

### DETAILED DESCRIPTION

According to an embodiment, a video transmitter includes an encoding unit and a communication unit. The encoding unit is configured to encode each frame per one or more lines to generate a code, each frame making up a video signal. The communication unit is configured to transmit the code to a video receiver and configured to receive an acknowledgment from the video receiver, the acknowledgment indicating whether or not the video receiver has been able to receive the code. The encoding unit encodes a following line in consideration of the acknowledgment.

Hereafter, embodiments will be described with reference to the appended drawings.

### First Embodiment

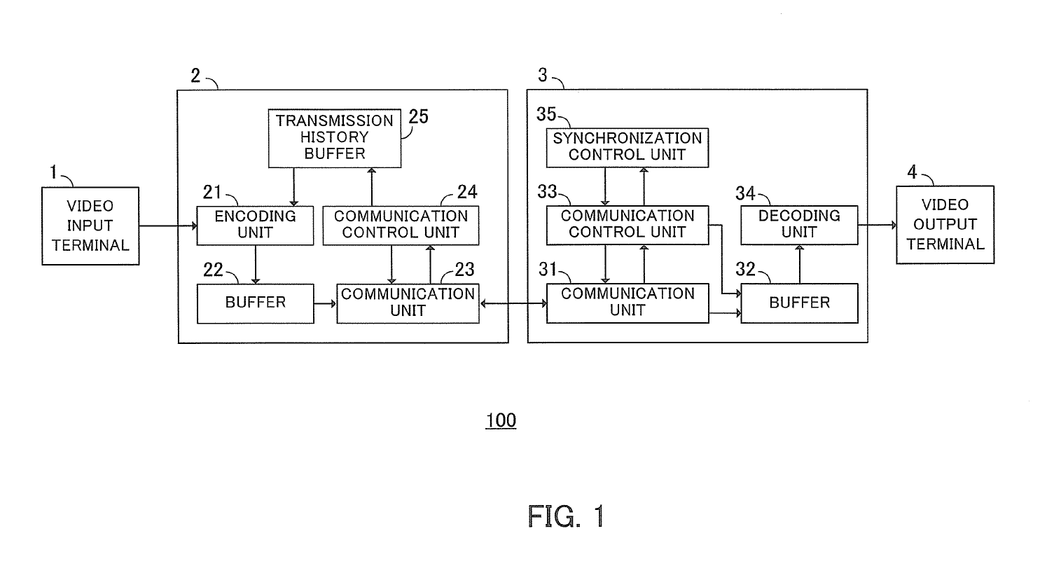

FIG. 1 is a block diagram of a video transceiver system 100 according to a first embodiment. The video transceiver system 100 has a video input terminal 1, a video transmitter 2, a video receiver 3, and a video output terminal 4.

The video input terminal 1 inputs a video signal to the video transmitter 2 when the video transmitter 2 is connected to an output terminal of the video input terminal 1. The video transmitter 2 encodes and compresses the video signal, and transmits this to the video receiver 3. The transmission path used for the transmission may be wireless or may be wired. It is possible to reduce the band for the transmission path by transmitting compressed video signals.

The video receiver 3 receives the encoded video signal and decodes this. The video receiver 3 then outputs the decoded video signal to the video output terminal 4. The video output terminal 4 displays a video corresponding to the video signal from the video receiver 3. Hereafter, the video transmitter 2 and the video receiver 3 are described in detail.

The video transmitter 2 has an encoding unit 21, a buffer 22, a communication unit 23, a communication control unit 24, and a transmission history buffer 25.

The encoding unit 21 encodes and compresses video signals. More specifically, the encoding unit 21 encodes each frame that makes up a video signal, per N lines (N being a predetermined integer equal to or greater than 1). These N lines constitute transmission units.

The encoding unit 21 is able to select whichever of intra-frame prediction and inter-frame prediction has the smallest amount of generated code, as the encoding method for each transmission unit. Intra-frame prediction is a method for encoding in which reference is made to only the pixels included in the N lines, which are the transmission units. Inter-frame prediction is a method for encoding in which reference is also made to the pixels included in a preceding frame (the frame that is one frame earlier in the present embodiment). Generally, inter-frame prediction is often able to have a smaller amount of code. The encoding unit 21 internally decodes encoded image data once, and stores this in a reference image buffer as a reference image for the inter-frame prediction thereafter. The reference image buffer has an address that corresponds to the location of a line, and a decoded image is stored in a corresponding address. In inter-frame prediction, pixel data of the corresponding address is read from this reference image buffer and used as a reference image.

Hereafter, in each frame, N lines, which are the transmission units, from an (n−1)N^{th} line to an (nN−1)^{th} line are referred to as the “transmission units of line number n”. A code generated by encoding the transmission units of this line number n is referred to as the “code for line number n” (n being an integer equal to or greater than 1 and equal to or less than (H/N)−1, and H being an integer equal to or greater than the number of lines of a video signal and the smallest integer that is a multiple of N).

In addition, the encoding unit 21 attaches a transmission header to the generated code and temporarily stores this in the buffer 22. The header includes information indicating the line number n of the code. The communication unit 23 reads the code from the buffer 22, and transmits this to the video receiver 3. However, due to the loss or delay of a packet in the transmission path, the video receiver 3 is sometimes not able to receive the code by the decoding start time of the code for the line number n that has been set with respect to a display position in the frame.

Therefore, for each line number, the communication unit 23 receives, from the video receiver 3, a 1-bit acknowledgment ACK that indicates whether or not the video receiver 3 has been able to receive the code. The acknowledgment ACK is set for each line number to “V” (valid) if it has been possible for the code to be received, and to “I” (invalid) if it has not been possible for the code to be received.

The communication control unit 24 controls the transmission timings of codes transmitted by the communication unit 23. Furthermore, the communication control unit 24 stores received acknowledgments ACK in the transmission history buffer 25.

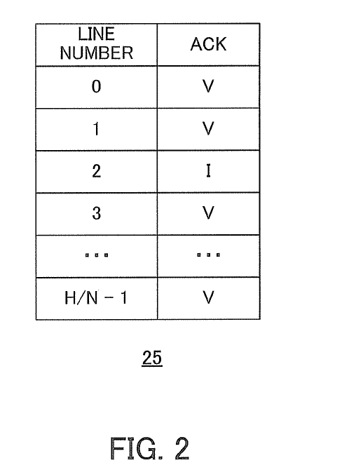

FIG. 2 is a drawing depicting an example of the structure of the transmission history buffer 25. Acknowledgments ACK are stored with the line number n serving as an index. In the example of FIG. 2, the video receiver 3 has been able to receive codes for line numbers 0, 1, and 3, but has not been able to receive a code for line number 2.

Hereafter, the transmission units of line numbers for which the acknowledgments ACK are set to “V” or “I” are referred to as “V regions” and “I regions” respectively.

As one feature of the present embodiment, the encoding unit 21 of FIG. 1 encodes following lines in consideration of the acknowledgments ACK stored in the transmission history buffer 25. That is, the encoding unit 21 encodes following lines without referring to lines (I regions) that the video receiver 3 has not been able to receive. A following line may be the following line in the frame being encoded by the encoding unit 21, or may be a line in a subsequent frame.

In this way, even if the video receiver 3 has not been able to receive part of a frame, the video receiver 3 can decode a code correctly because of no need to refer to the regions which have not been received. Therefore, the video transmitter 2 does not have to resend codes even if the transmission of a code has failed.

The video receiver 3 of FIG. 1 has a communication unit 31, a buffer 32, a communication control unit 33, a decoding unit 34, and a synchronization control unit 35.

The communication unit 31 receives a header-attached code from the video transmitter 2, and temporarily stores the code in the buffer 32. Furthermore, the communication unit 31 transmits acknowledgments ACK set by the communication control unit 33 to the video transmitter 2.

It should be noted that it is desirable for the communication unit 31 to transmit acknowledgments ACK by means of a protocol by which transmission is definitely possible. For example, if the video transmitter 2 has not been able to receive an acknowledgment ACK, it is permissible to request the resending of the acknowledgment ACK from the video transmitter 2 to the video receiver 3. Since an acknowledgment ACK is 1 bit, there is no great increase in the amount of data transmitted between the video transmitter 2 and the video receiver 3 even when resending is carried out.

On the basis of the header, the communication control unit 33 determines whether or not the codes for each line number have been able to be received prior to a prescribed time. If a code has been able to be received, the communication control unit 33 sets the acknowledgment ACK to “V”. On the other hand, if a code has not been able to be received, the communication control unit 33 sets the acknowledgment ACK to “I”.

The decoding unit 34 decodes a code input from the buffer 32, and obtains the original video signal. This video signal is output to the video output terminal 4. Furthermore, the decoding unit 34 stores the obtained video signal in an internal reference image buffer (not depicted). The reference image buffer has an address that corresponds to the position of a decoded line, and a decoded image is stored in a corresponding address. If a code is generated by means of inter-frame prediction, the decoding unit 34 reads a pixel from the address of a reference range of a preceding frame stored in the reference image buffer, and refers to this to carry out decoding. On the other hand, if a code is generated by means of intra-frame prediction, the decoding unit 34 refers to only a pixel included in the code to carry out decoding.

The synchronization control unit 35 controls the timing at which data is input from the buffer 32 to the decoding unit 34, in accordance with the video display timing of the video output terminal 4, through the communication control unit 33 and the communication unit 31.

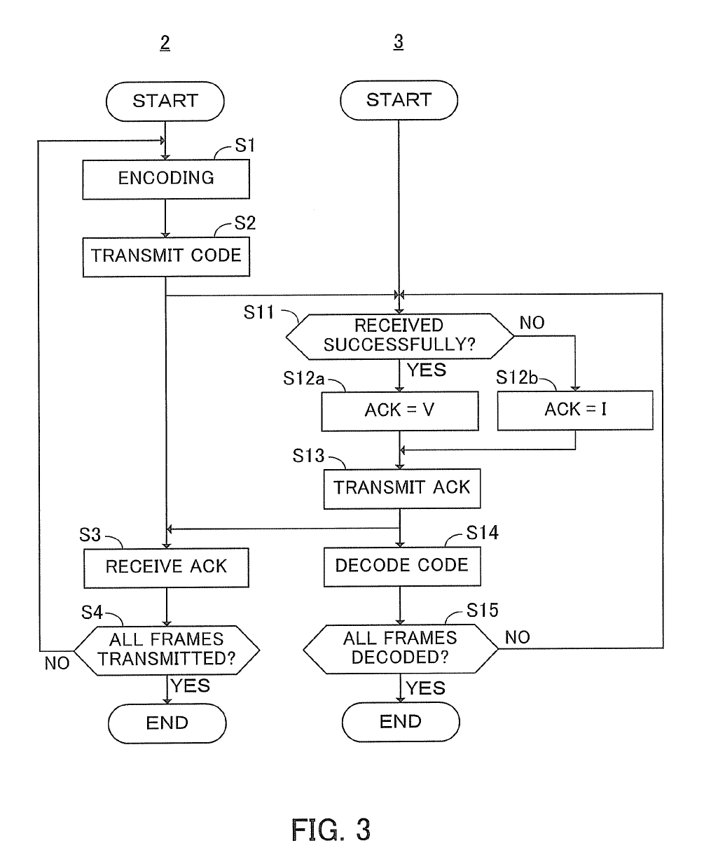

FIG. 3 is a sequence diagram depicting an example of processing performed by the video transceiver system 100. The encoding unit 21 encodes each frame per N lines (S1). It should be noted that the encoding unit 21 encodes the first frame by means of intra-frame prediction. Furthermore, the encoding unit 21 decodes the second frame and thereafter by means of intra-frame prediction or inter-frame prediction, in consideration of the acknowledgments ACK. A generated code is decoded in an internal decoder at the same time as having a header attached thereto and being stored in the buffer 22, and is stored in the reference image buffer within the encoding unit 21 as a reference image for the encoding of the next line and thereafter. Then, in accordance with the timing control performed by the communication control unit 24, the communication unit 23 transmits the header and the code stored in the buffer 22 to the video receiver 3 (S2).

The communication unit 31 receives the header and the code. Then, the communication control unit 33 refers to the header, and determines whether or not the code for a line number n has been able to be received prior to the prescribed time (S11). If the code has been able to be received (YES in S11), the communication control unit 33 sets the acknowledgment ACK to “V” (S12a). If the code has not been able to be received (NO in S11), the communication control unit 33 sets the acknowledgment ACK to “I” (S12b).

This acknowledgment ACK is transmitted to the video transmitter 2 by the communication unit 31 (S13). On the other hand, a code that has been able to be received is stored in the buffer 32. Then, the decoding unit 34 decodes the code input from the buffer 32 in accordance with the timing control performed by the synchronization control unit 35 (S14). The video signal obtained by the decoding is output to the video output terminal 4, and is also stored in the reference image buffer within the decoding unit 34. The video receiver 3 repeats the aforementioned processing until the decoding of all of the frames has been completed (NO in S15).

The acknowledgments ACK transmitted from the video receiver 3 are received by the communication unit 23 (S3). The communication unit 23 stores the received acknowledgments ACK in the transmission history buffer 25 through the communication control unit 24 for each line number. Even if an acknowledgment ACK for a line number n is “I”, the communication unit 23 does not resend the code for the line number n. Then, the encoding unit 21 determines a reference image region that is able to be used for inter-frame encoding in consideration of an acknowledgment ACK in the transmission history buffer 25, and also selects whichever of inter-frame encoding and intra-frame encoding has the better compression efficiency. Then, the encoding unit 21 uses the selected encoding method, carries out encoding for the following line, and transmits a code to the video receiver 3 (S1, S2). The video transmitter 2 repeats the aforementioned processing until the transmission of all of the frames has been completed (NO in S4).

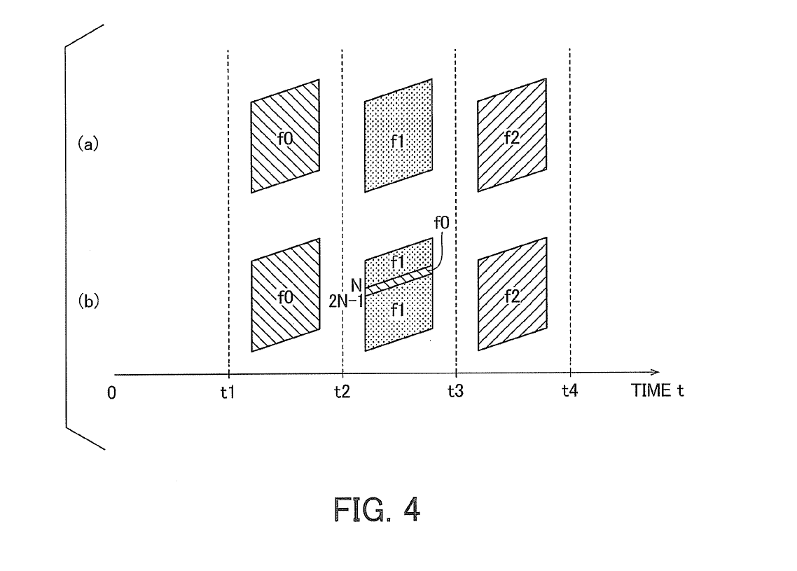

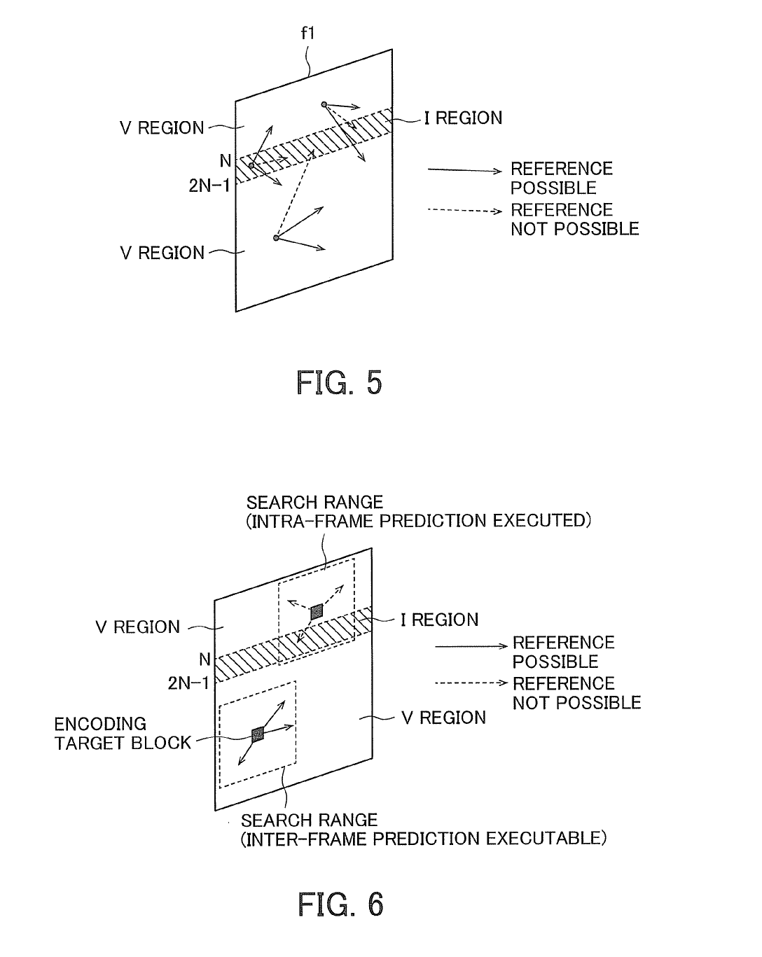

FIGS. 4 to 6 are drawings schematically illustrating the processing performed by the video transceiver system 100. In FIG. 4, frames f0 to f2 are included in a video signal. FIG. 4 (a) depicts frames that are transmitted from the video transmitter 2 to the video receiver 3. This is equivalent to the content of the reference image buffer of the encoding unit 21. FIG. 4 (b) depicts frames that the video receiver 3 has been able to receive. This is equivalent to the content of the reference image buffer of the decoding unit 34. In FIGS. 5 and 6, reference relationships according to inter-frame prediction are depicted by arrows, the origin points of the arrows represent the pixels of an encoding target frame, and the tip ends of the arrows represent the pixels of frames to be referred to when encoding is carried out.

As depicted in FIG. 4 (b), with regard to frame f0, the codes for all line numbers are received by the video receiver 3 (t1 to t2). On the other hand, with regard to frame f1, the video receiver 3 has not been able to receive the code for line number 2 (namely, the region of the N^{th} to (2N−1)^{th} lines), but has been able to receive other codes (t2 to t3).

In this case, at time t3 at which the video transmitter 2 completes the transmission of frame f1, the transmission history buffer 25 is as depicted in FIG. 2. In other words, only the acknowledgment ACK for the code for line number 2 is set to “I”.

Furthermore, at time t3 at which the video receiver 3 completes the decoding of frame f1, in the reference image buffer, although the decoded pixel data of frame f1 is stored for transmission units other than those of line number 2, the decoded pixel data of frame f0 remains for the transmission units of line number 2. At such time, as depicted in FIG. 5, on the basis of the acknowledgments ACK stored in the transmission history buffer 25, the encoding unit 21 encodes frame f2 without referring to the I region of line number 2 in frame f1 between time t3 and time t4. At such time, the encoding unit 21 may refer to V regions outside of line number 2 of frame f1 for which transmission has been successful between time t2 and time t3, to encode frame f2 by means of inter-frame prediction. Thus, it is possible to minimize the regions which are not able to be referenced in inter-frame prediction, and to increase encoding efficiency.

Alternatively, as depicted in FIG. 6, if an I region is included in a range (search range) that has a possibility of being referenced when inter-frame prediction is carried out, the encoding unit 21 may encode frame f2 by means of intra-frame prediction without referring to frame f1. Thus, the implementation of the encoding unit 21 is able to be simplified.

By carrying out encoding without referring to regions that the video receiver 3 has not been able to receive, the video receiver 3 is able to decode the codes for frame f2 without it being necessary to refer to regions of frame f1 that were not able to be received, in other words, regions for which the codes for frame f0 remain in the buffer 32.

In this way, in the first embodiment, acknowledgments ACK indicating whether or not the video receiver 3 has been able to receive the codes for line numbers are transmitted from the video receiver 3 to the video transmitter 2. Since the encoding unit 21 refers to only V regions that the video receiver 3 has been able to receive to encode a video signal, the encoding unit 21 and the decoding unit 34 execute their process with the same reference images. Therefore, the decoding unit 34 is able to correctly decode codes without codes being resent even when a communication error has occurred, and is able to reduce the degradation of video to be able to display high-quality video. Since resending is not additionally carried out, it is possible to reduce transmission delays from the video input terminal 1 to the video output terminal 4.

### Second Embodiment

In a second embodiment, in addition to indicating whether or not a video receiver has been able to receive codes, acknowledgments indicate whether or not the video receiver has been able to decode the codes. Hereafter, a description is given focusing on the points that are different from the first embodiment.

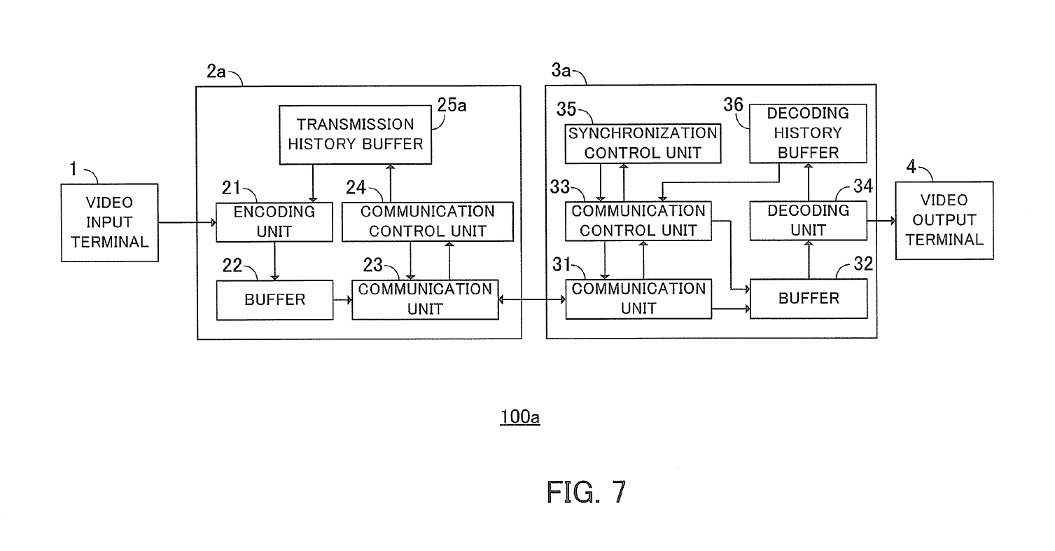

FIG. 7 is a block diagram of a video transceiver system 100a according to the second embodiment. The video transceiver system 100a has the video input terminal 1, a video transmitter 2a, a video receiver 3a, and the video output terminal 4. The video receiver 3a additionally has a decoding history buffer 36. The decoding unit 34 writes whether or not it has been able to decode codes for line numbers to the decoding history buffer 36.

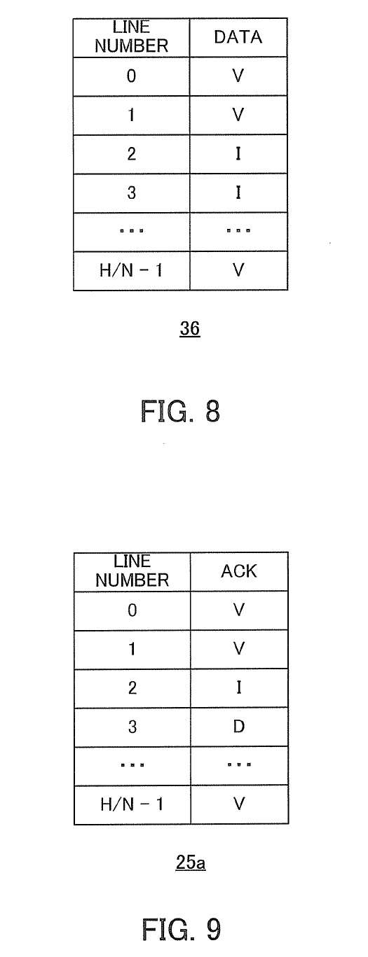

FIG. 8 is a drawing depicting an example of the structure of the decoding history buffer 36. The line number n serves as an index, and 1-bit data indicating whether or not the decoding unit 34 has been able to decode the code for a line number n is stored. That is, for each line number, the decoding unit 34 sets “V” (valid) if the decoding unit 34 has been able to carry out decoding, and sets “I” (invalid) if the decoding unit 34 has not been able to carry out decoding. In the example of FIG. 8, the decoding unit 34 has not been able to decode the codes for line numbers 2 and 3, but has been able to decode the other codes.

Here, cases where it has not been possible to carry out decoding include when the video receiver 3a has not been able to receive a code from the video transmitter 2a, and when the video receiver 3a has been able to receive the code but the decoding processing performed by the decoding unit 34 has not been carried out in time. The case where the decoding processing has not been carried out in time means that a code has not arrived by the decoding start time for the line in synchronization with the output timing to the video output terminal 4 due to reasons such as a processing delay or a transmission delay. With regard to lines for which decoding processing has not been carried out in time, decoding processing is not executed, and a decoded image is not stored in the reference image buffer. Therefore, the decoding unit 34 is not able to refer to the image of lines correctly for which decoding processing has not been carried out in time, to decode the following line.

A communication control unit 33 then generates a 2-bit acknowledgment ACK for each line number on the basis of the data stored in the decoding history buffer 36. That is, the communication control unit 33 sets acknowledgments ACK to “I” if the video receiver 3a has not been able to receive a code. Furthermore, the communication control unit 33 sets acknowledgments ACK to “V” if the video receiver 3a has been able to receive a code, and if the decoding unit 34 has been able to carry out decoding. Furthermore, the communication control unit 33 sets acknowledgments ACK to “D” (dirty) if the video receiver 3a has been able to receive a code but the decoding unit 34 has not been able to carry out decoding.

These kinds of acknowledgments ACK are transmitted from the communication unit 31 to the video transmitter 2a. The acknowledgments ACK are then received by the communication unit 23, and are stored in a transmission history buffer 25a by the communication control unit 24.

FIG. 9 is a drawing depicting an example of the structure of the transmission history buffer 25a. The difference between FIG. 9 and FIG. 2 is that the three values of “V”, “I”, and “D” are able to be stored as acknowledgments ACK. In the example of FIG. 9, the acknowledgments ACK for the codes for line numbers 2 and 3 are “I” and “D” respectively, and the acknowledgments ACK for the other codes are “V”. This means that the decoding unit 34 has not decoded the pixels of the regions for line numbers 2 and 3, and has not been able to refer to the same image as the encoding unit 21 has referred.

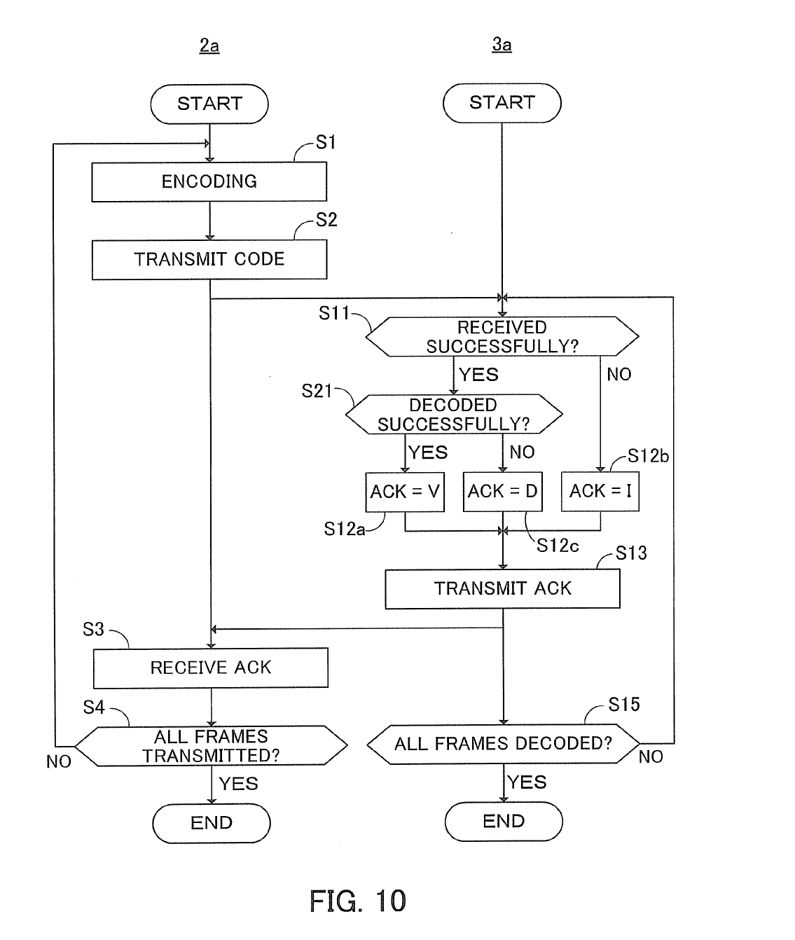

FIG. 10 is a sequence diagram depicting an example of processing performed by the video transceiver system 100a. If it has not been possible to receive the code for each line number (NO in S11), the communication control unit 33 sets the acknowledgment ACK to “I” (S12b). If it has been possible to receive the code (YES in S11), the decoding unit 34 decodes the code.

If it has been possible to carry out decoding (YES in S21), the decoding unit 34 sets “V” in the decoding history buffer 36. Then, on the basis of this “V”, the communication control unit 33 sets the acknowledgment ACK to “V” (S12a).

On the other hand, if the decoding unit 34 has not carried out the decoding in time (NO in S21), the decoding unit 34 sets “I” in the decoding history buffer 36. Then, on the basis of this “I”, the communication control unit 33 sets the acknowledgment ACK to “D” (S12c).

This acknowledgment ACK is transmitted to the video transmitter 2a by the communication unit 31 (S13). The communication unit 23 receives the acknowledgment ACK (S3), and stores this in the transmission history buffer 25.

Then, the encoding unit 21 encodes the following line in consideration of the acknowledgment ACK (S2). That is, the encoding unit 21 encodes the following line without referring to regions for which the acknowledgment ACK is “I” or “D”.

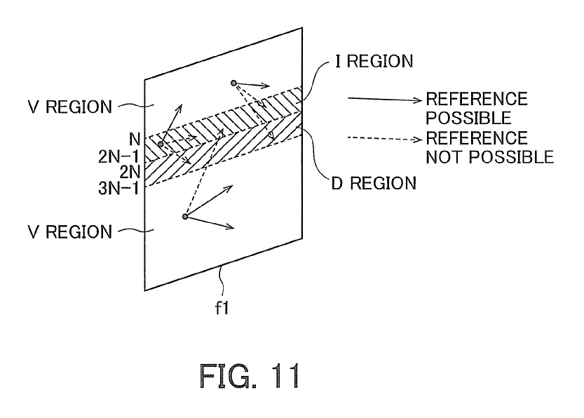

FIG. 11 is a drawing schematically illustrating the processing performed by the video transceiver system 100a. In the example of FIG. 11, it is assumed that the acknowledgments ACK for the codes for line numbers 2 and 3 are “I” and “D” respectively, and the acknowledgments ACK for the other codes are “V”. The encoding unit 21 encodes frame f2 without referring to the I region for line number 2 and the D region for line number 3 in frame f1. This is because the region for which the acknowledgment ACK has been set to “D” is not decoded in the video receiver 3a, and it has not been possible to refer to the same image as the reference image of the encoding unit 21 when the following line is decoded.

In this situation, in the same manner as in FIG. 5, the encoding unit 21 may refer to V regions outside of line numbers 2 and 3 in frame f1, to encode frame f2 by means of inter-frame prediction. Alternatively, the encoding unit 21 may encode frame f2 by means of intra-frame prediction without referring to frame f1.

In the second embodiment, the encoding unit 21 does not refer to I regions and D regions when encoding is carried out. By means of the acknowledgments ACK, the video transmitter 2a is able to determine whether reference is not carried out because the transmission of a code has failed, or whether reference is not carried out because the decoding has failed. Therefore, it is desirable for the encoding unit 21 to increase the compression ratio when the transmission of a code has failed, more specifically, when acknowledgments ACK that have been set to “I” are frequently received. It is therefore possible for the band required for the transmission of codes to be minimized, and it is possible to expect a reduction in transmission failures. For example, it becomes possible to use the band effectively by setting the compression ratio to be high when all of the lines in a reference range are “I” in the encoding of a certain line, and when “I” has been received a prescribed number of times or more within one frame, and by setting the compression ratio to be low when all of the lines in a reference range are “V” in the encoding of a certain line, and when “V” has been received a prescribed number of times or more within one frame.

In this way, in the second embodiment, acknowledgments ACK indicating whether or not the video receiver 3a has been able to receive the codes for line numbers, and whether or not the video receiver 3a has been able to decode the codes are transmitted to the video transmitter 2a. Therefore, the video transmitter 2a is able to appropriately adjust the compression ratio of video signals.

### Third Embodiment

In a third embodiment, the meaning of “D” in the second embodiment is changed, and acknowledgments that have been set to “D” are counted at the video transmitter side.

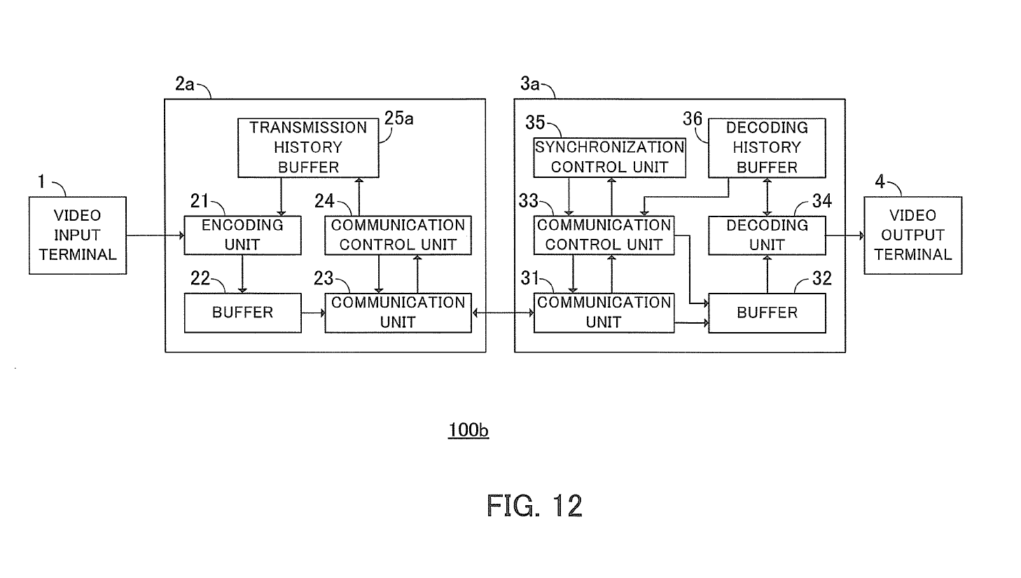

FIG. 12 is a block diagram of a video transceiver system 100b according to the third embodiment. One difference between the third embodiment and the second embodiment is that the decoding unit 34 refers to the decoding history buffer 36 to carry out decoding.

If the decoding unit 34 has not been able to receive a code by the decoding start time for a line number n, the decoding unit 34 stores “I” for the appropriate entry in the decoding history buffer 36. Furthermore, if the decoding unit 34 has been able to receive a code by the decoding start time, and has been able to carry out decoding without an I region being included in the reference image, the decoding unit 34 stores “V” for the appropriate entry. Lines that are encoded by means of intra-frame encoding are always “V” as they are able to be referenced. If decoding is carried out with reference to a pixel in an I region, the decoding unit 34 stores “D” for the appropriate entry in the decoding history buffer 36. Furthermore, “D” is stored for the appropriate entry also if a line that has been referenced when decoding is carried out does not include an I region but does include a D region.

The communication unit 31 reads the value of an entry n in the decoding history buffer 36 through the communication control unit 33 when the decoding of a line number n is completed, and transmits the value to the video transmitter 2a.

Transmission delays occur in unstable transmission paths such as wireless paths. Therefore, decoding is not carried out if the decoding start time has already passed even if a code is received for a certain line at the video receiver 3a. Furthermore, if the video input terminal and the video output terminal are different, generally it is difficult to synchronize their video timings. Therefore, in the case where, with respect to a certain line number n, the difference between the time at which input is carried out by the video input terminal and the time at which output is carried out by the video output terminal is large, when waiting is performed for the acknowledgment ACK for line number n in order for the encoding of line number (n+1) to be started, a delay occurs that is equivalent to the time spent waiting. Consequently, the encoding unit 21 deems that decoding will be carried out correctly and starts the encoding of the line number (n+1) without waiting for the acknowledgment ACK for line number n, depending on the situation, for line numbers (n−1), (n−2) . . . . If line number (n+1) has been encoded with reference to line number n, but in actuality line number n has not been decoded in the decoding unit 34, the entry for line number (n+1) in the decoding history buffer 36 is “D”.

Furthermore, another difference with the second embodiment is that the configuration of the transmission history buffer 25a is different.

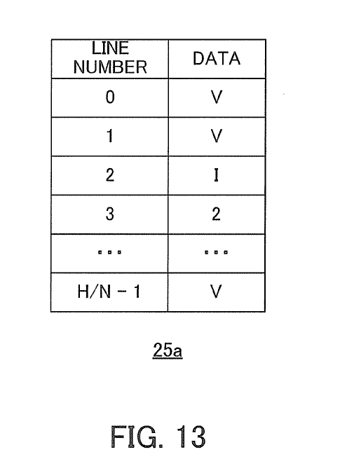

FIG. 13 is a drawing depicting another example of the structure of the transmission history buffer 25a. In the transmission history buffer 25a, data for “the number of consecutive Ds” is stored in addition to “V” and “I”. That is, if the acknowledgment ACK for a certain line number is “D”, the communication control unit 24 counts the number of consecutive acknowledgments ACK for line numbers that have been set to “D”, and causes that count value to be stored in the transmission history buffer 25a. Then, the communication control unit 24 sets “I” in the transmission history buffer 25a if the count value becomes equal to or greater than a predetermined threshold value TH (TH being an integer equal to or greater than 1). The example of FIG. 13 depicts that the acknowledgment ACK for the code for line number 3 is set to “D” for two frames consecutively. If the threshold value TH were “3”, and the acknowledgment ACK for line number 3 of the next frame were “D”, “I” would be set in the data of line number 3 in the transmission history buffer 25a.

The encoding unit 21 carries out encoding on the basis of the data stored in the transmission history buffer 25a. Here, the reason that the encoding unit 21 does not refer to I regions (the I region of line number 2 in FIG. 9) is the same as in the second embodiment. However, when encoding is carried out, the encoding unit 21 uses, as reference images, D regions (the D region in line number 3 in FIG. 9) in which “D” has been set a number of consecutive times. In other words, in the third embodiment, the encoding unit 21 is permitted to refer to D regions if the number of consecutive “Ds” is less than the threshold value TH.

For example, if the value of “D” is 2, the video signal of three frames earlier is stored in the region for the corresponding line number in the reference image buffer of the decoding unit 34. On the other hand, the video signal of one frame earlier is stored in the reference image buffer of the encoding unit 21. However, if there are no quick movements in the video, there is no considerable difference between the video signal of one frame earlier and the video signal of three frames earlier. Therefore, even if the decoding unit 34 carries out decoding by referring to three frames earlier when normally reference should be made to one frame earlier, there is no considerable deterioration in image quality.

On the other hand, if there is a large number of consecutive “Ds”, video signals from much earlier remain in the reference image buffer of the decoding unit 34. As result, when the decoding unit 34 decodes codes with reference to such video signals, there is a risk of the image quality degradation. Therefore, in the same manner as with I regions, the encoding unit 21 does not refer to regions in which the number of consecutive “Ds” has reached the threshold value TH. The value of “D” is reset to “V” if the corresponding line has been subjected to intra-frame encoding, or if subjected to inter-frame encoding in such a way that only “V” regions are referenced.

Here, the threshold value TH may be a predetermined constant, or may be variably set in accordance with video signals. In other words, it is desirable for the threshold value TH to be set to be low if there are quick movements in a video, and for the threshold value TH to be set to be high if the video is close to a still image. For example, the communication control unit 24 sets the threshold value TH on the basis of the correlation between an encoding target frame that is encoded by the encoding unit 21, and a reference frame to be referred to when encoding is carried out.

Specifically, the communication control unit 24 sets the threshold value TH on the basis of the average value of motion vectors for the whole of the frame when the encoding unit 21 carries out encoding by means of inter-frame prediction, the average value of motion vectors close to lines of transmission units for which encoding is carried out, and the pixel value differences between a reference image and a local decoded image, and so forth.

In this way, in the third embodiment, the number of consecutive acknowledgments ACK that are “D” is counted. If the number of consecutive acknowledgments ACK that are “D” is less than the threshold value TH, the encoding unit 21 also refers to D regions to carry out encoding. Therefore, it is possible to increase compression efficiency with expanding the reference region that is able to be used for inter-frame prediction while reducing image quality degradation.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A video transmitter comprising:
an encoding unit configured to encode each frame per one or more lines to generate a code, each frame making up a video signal; and
a communication unit configured to transmit the code to a video receiver and configured to receive an acknowledgment from the video receiver, the acknowledgment indicating whether or not the video receiver has been able to receive the code,
the encoding unit encoding a following line in consideration of the acknowledgment.

2. The video transmitter according to claim 1, wherein the encoding unit encodes the following line based on the acknowledgment without referring to the one or more lines corresponding to a code that the video receiver has not been able to receive.

3. The video transmitter according to claim 1, wherein the communication unit does not resend the code to the video receiver even if the video receiver has not been able to receive the code.

4. The video transmitter according to claim 1, wherein the acknowledgment comprises:
first information indicating whether or not the video receiver has been able to receive the code; and
second information indicating whether or not the video receiver has been able to decode the received code.

5. The video transmitter according to claim 4, wherein
the encoding unit compresses the video signal by encoding the video signal, and
the encoding unit adjusts a compression ratio when compressing the video signal, based on the first information.

6. The video transmitter according to claim 1, wherein the acknowledgment comprises:
first information indicating whether or not the video receiver has been able to decode the code; and
second information indicating whether or not the video receiver has carried out decoding with reference to a pixel that the video receiver has not been able to decode.

7. The video transmitter according to claim 6, wherein the encoding unit encodes the following line based on the second information, in consideration of the number of frames for which a code, that the video receiver has not been able to decode, continues.

8. The video transmitter according to claim 7, wherein, if a code that the video receiver has not been able to decode continues for a predetermined number of frames or more, the encoding unit encodes the following line without referring to the one or more lines corresponding to that code, and
the predetermined number of frames is set based on a correlation between an encoding target frame that is encoded by the encoding unit, and a reference frame to be referred to when encoding is carried out.

9. A video transceiver system comprising a video transmitter and a video receiver,
the video transmitter comprising:
an encoding unit configured to encode each frame per one or more lines to generate a code, each frame making up a video signal; and
a first communication unit configured to transmit the code to the video receiver and configured to receive an acknowledgment from the video receiver, the acknowledgment indicating whether or not the video receiver has been able to receive the code,
the encoding unit encoding a following line in consideration of the acknowledgment, and
the video receiver comprising:
a second communication unit configured to receive the code from the video transmitter, and configured to transmit the acknowledgment to the video transmitter; and
a decoding unit configured to decode the code transmitted from the video transmitter.

10. The video transceiver system according to claim 9, wherein the encoding unit encodes a following line based on the acknowledgment without referring to the one or more lines corresponding to a code that the video receiver has not been able to receive.

11. The video transceiver system according to claim 9, wherein the first communication unit does not resend the code to the video receiver even if the video receiver has not been able to receive the code.

12. The video transceiver system according to claim 9, wherein the acknowledgment comprises:
first information indicating whether or not the video receiver has been able to receive the code; and
second information indicating whether or not the video receiver has been able to decode the received code.

13. The video transceiver system according to claim 12, wherein
the encoding unit compresses the video signal by encoding the video signal, and
the encoding unit adjusts a compression ratio when compressing the video signal, based on the first information.

14. The video transceiver system according to claim 9, wherein the acknowledgment comprises:
first information indicating whether or not the video receiver has been able to decode the code; and
second information indicating whether or not the video receiver has carried out decoding with reference to a pixel that the video receiver has not been able to decode.

15. The video transceiver system according to claim 14, wherein the encoding unit encodes the following line based on the second information, in consideration of the number of frames for which a code, that the video receiver has not been able to decode, continues.

16. The video transceiver system according to claim 15, wherein, if a code that the video receiver has not been able to decode continues for a predetermined number of frames or more, the encoding unit encodes the following line without referring to the one or more lines corresponding to that code, and
the predetermined number of frames is set based on a correlation between an encoding target frame that is encoded by the encoding unit, and a reference frame to be referred to when encoding is carried out.

17. A video transmission method comprising:
encoding each frame per one or more lines to generate a code, each frame making up a video signal;
transmitting the code to a video receiver;
receiving an acknowledgment from the video receiver, the acknowledgment indicating whether or not the video receiver has been able to receive the code; and
encoding a following line in consideration of the acknowledgment.

18. The video transmission method according to claim 17, wherein, in the encoding, the following line is encoded based on the acknowledgment without referring to the one or more lines corresponding to a code that the video receiver has not been able to receive.

19. The video transmission method according to claim 17, wherein the acknowledgment comprises:
first information indicating whether or not the video receiver has been able to receive the code; and
second information indicating whether or not the video receiver has been able to decode the received code.

20. The video transmission method according to claim 17, wherein the acknowledgment comprises:
first information indicating whether or not the video receiver has been able to decode the code; and
second information indicating whether or not the video receiver has carried out decoding with reference to a pixel that the video receiver has not been able to decode.
